(19) United States
(12) Patent Application Publication
(10) Pub. No.: US 2005/0160473 A1
(43) Pub. Date: Jul. 21, 2005

(54) Context aware transmission management method

(76) Inventor: Nimrod Gal-Oz, Lehavim (IL)

Correspondence Address: SALTAMAR INNOVATIONS, 30 FERN LANE, SOUTH PORTLAND, ME, 04106, US

(21) Appl. No.: 10/517,407

(22) PCT Filed: Jul. 14, 2003
(86) PCT No.: PCT/US03/22279

Related U.S. Application Data
(60) Provisional application No. 60/395,920, filed on Jul. 15, 2002.

(51) Int. Cl. H04N 7/173

(52) U.S. Cl. 725/118; 725/126; 725/117

(57) ABSTRACT

The present invention comes to simplify and optimize the management of data transmission to set-top boxes for interactive and addressable applications. The result is achieved by abstraction of the transmission process (40) for the application and addition of meta-data (20) to each message/stream using the invention, enabling automatic routing of the data (50) through the most suitable transmission path in real-time (70).

### FILED OF THE INVENTION

This invention relates to methods of transmitting data in broadband networks, and more specifically to methods of optimising data transmission paths according to the data context in a broadband television distribution systems.

### BACKGROUND

The following example relate to cable television distribution system. However people skilled in the art will recognize that the principle described herein are equally applicable to other broadband television distribution systems.

Broadband cable networks usually support various ways to transmit data from the head-end to subscriber's set-top boxes. These include a subset of, or all of:
In-Band streaming of Video
In-Band streaming of audio
In-Band Streaming of data
In-Band data carousel
Out-of-Band data carousel (a continuous periodic transmission of data item over out of band channel)
Out-of-Band data messages

In a typical distribution system In-band channels are QAM modulated, while out-of-band and return channels are QPSK modulated.

In order to receive In-Band transmissions, the set-top box at the subscriber's premises must be tuned to a specific QAM channel. Out-of-Band (o.o.b.) transmissions are received on the separate QPSK channel.

Typical broadband cable networks provide relatively narrow out-of-band channels, which are shared by all the applications provided on each cable node. On the other hand, most digital set top boxes deployed only have one QAM tuner, thus they are not able to receive both regular video programs and separate in-band data streams at the same time.

In order to be able to implement interactive or addressable applications that involve transfer of large amounts of data to the subscriber's set-top boxes, it is essential to utilize all the available transmission methods efficiently.

A so-called ‘carousel’ mechanism is used for transmission of common data to the set-top boxes (such as application code, Program Guides, etc.). It is a constant periodic transmission of data items that are received and stored on the set-top boxes according to need. There are in-band carousels, and out-of-band carousels (according to the carrying transmission path). Data items that are put on the carousel are part of the system and application configuration. As a rule of thumb, carousel bandwidth is considered an expensive resource, since all the applications and services share the same carousel bandwidth.

It is a common to transmit data to a single set-top box or a subset of set-top boxes from the collection of all the set-top boxes in a television distribution plant. The nature of the data type to be transmitted often dictates several constraints that the transmission path has to provide. Considerations such as bandwidth, latency and the like are examples of such constraints. thus for example a voice or video transmission occurring in real time can not sustain significant latency, while a data programming of the set-top boxes may utilize a low bandwidth path as both the data amount and the laxity of time constraints will prove a better utilization of the available paths.

Presently selection of the transmission path is done manually by the programmer. This causes inefficient use of the bandwidth as oftentimes it is possible to utilize a channel which at the time of transmission is better fitting for the data at hand. Therefore there is a need for better method of selecting the data path by which the data is transmitted to the set-top box.

It is thus an aim of the invention to provide a mechanism for automatic selection of the data path to by which data is transmitted to the set-top box, based on the context and type of the data.

### SUMMARY

The present invention comes to simplify and optimise the management of data transmission to the set-top boxes for interactive and addressable applications, and is applicable to all types of head-end based applications and middleware over broadband cable and wireless networks.

The result is achieved by abstraction of the transmission process for the application, and addition of meta-data to each message/stream using the invention, enabling automatic routing of the data through the most suitable transmission path in real-time.

The selection of the transmission path (from the list above) is made based on one or more of the following criteria:
Transmission paths available on that context at the moment of selection. (e.g. is the target set-top box tuned to a channel on which streaming data is available? Is the data available on the in-band carousel? and the like)
Type of data audio/video/general data (e.g. can the data be streamed down as video/audio?).
Size of data.
Set-top box capabilities (e.g. does the set-top box have enough resources to handle the data?).
Latency constraints on the message.
Available bandwidth on each path.

The path selection described above and actual data transmission is seamless to the application, which continues to provide the same content, no matter what path was selected. The selection may change according to varied criteria such as changing current load conditions, general status of the network, or data context without any need for the application to become aware of the change.

Thus in an aspect of the invention there is provided a method for selecting optimized transmission in a television distribution network, the method comprising the steps of: receiving information relating to data to be transmitted to at least one set-top box, said information comprising metadata related to said data to be transmitted, and an identification of said at least one set-top box; building a list of available transmission paths for the said set-top box; and selecting an optimal transmission path based on said list and said metadata.

Preferably said metadata comprises information selected from a list consisting of type of data to be transmitted, type of application that generated the data, type of application to receive the data, latency constraints of the data, or a combination thereof.

Also preferably, said step of building further comprises the step of retrieving information related to said set-top box from a database. Said information preferably comprise information on available transmission paths and capabilities of the set-top box.

More preferably, the method further comprises the step of querying said set-top box to obtain data indicative of available transmission paths thereto. Most preferably, the method includes both querying the set-top box and the database as described above. Optionally, the method also comprise getting information relating to network load and creating the list in accordance with the load data.

Preferably, the method further comprise the step of transmitting the data to the set-top box using said selected transmission path.

In another aspect of the invention there is provided an apparatus for selecting optimized transmission in a television distribution network, comprising a list creator, adapted to create a list of available transmission paths from the headend to a specified set-top box, or a group of specified set-top boxes and a data route selector, to automatically select the best applicable transmission path from said list for transmitting based on a policy applied to the combination of at least a data type to be transmitted and said list.

### BRIEF DESCRIPTION OF THE DRAWINGS

FIG. 1 depicts a general flow diagram of a method in accordance with the preferred embodiment of the present invention.

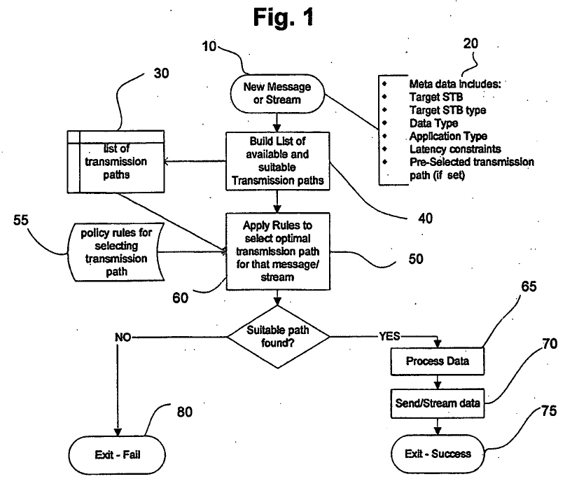

FIG. 2 depicts flow diagram of an example method for the transmission path selection.

FIG. 3 illustrates an example of the generation of available transmission path list.

FIG. 4 depicts a simplified block diagram of an apparatus according to a preferred embodiment of the invention.

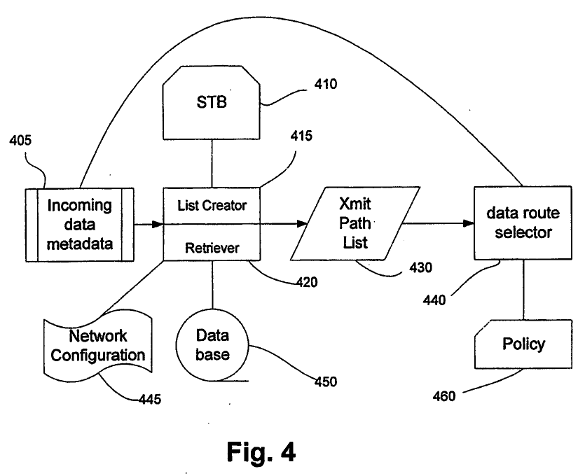

### DETAILED DESCRIPTION

The following are acronyms and general term definition that may aid in reading these specifications.

| | |
|---|---|
| EPG | Electronic Program Guide |
| STB | Set-Top Box |
| o.o.b. | Out-Of-Band |
| Carousel | A constant periodic transmission of data items that are |
| | received and selectively stored by the set-top boxes |
| | as needed |
| Application | Software components required for delivering a service |
| | to the end user. |
| | Server side of - the software components that reside on the |
| | server/s in the head-end. |
| | Client Side of - the software components that reside on the |
| | set-top box. |

The method embodiment described below is preferably applied to each messages sent to the set-top box, or to each new stream initiated. The steps are:
1. Build list 40 of transmission paths available for that message/stream:
2. Select 50 optimal transmission path from the list according to policy.
3. If no suitable path found—exit 80 (fail). Else, process data 65 to suite the selected transmission path.
4. Send/Stream data 70 to the set-top box-using the selected path.

The above method is preferably applied by a software routine in the headend, but may also be implemented in specialized hardware.

This method requires that a client capable of handling different transmission paths will be present on the set-top box. (This is may be achieved by a simple middleware client. Such client will enable video/audio streaming and o.o.b data transmission However such capacity may be built into the set-top box as a part of its native capabilities). A more sophisticated client will also enable in-band data streaming and/or carousel access.

The list of available transmission paths may include additional data such as bandwidth availability for each path.

Policy rules may be supplied as external data to the selection routine, or be hard-coded into the selection routine logic.

The following is a more detailed explanation of the various steps of the preferred embodiment of the invention.

The information attached to new message/stream to be transmitted using this embodiment will preferably include t the following details:
Target set-top box
Data type
Application Type
Latency constraints

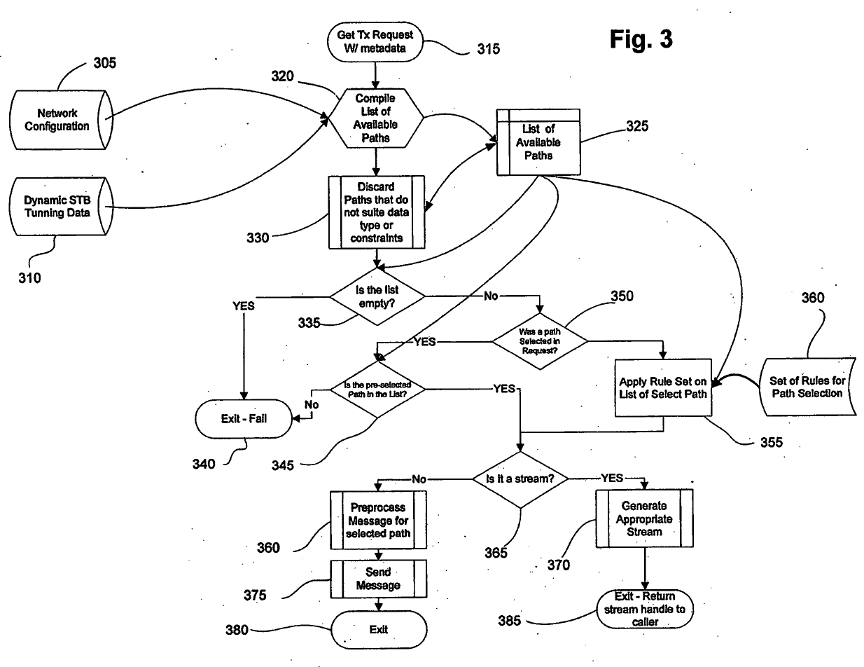

Based on these details and the configuration and status of the cable network, the selection of the optimal transmission path in this example is done as follows (reference is now made to FIG. 3):
1. If the transmission path was specified at message/stream initialization, place the selected path in the list of available paths. Else, build list of available transmission paths for that message/stream
   a. Identify target set-top box and its attributes. This may be achieved either statically from a database containing such information, by querying the set-top box, or by a combination thereof.
   b. Determine whether in-band transmission path is available for the requesting application and the target set-top box at time of transmission. If the path is available, add in-band data streaming to the transmission paths list. If the data is graphic—add video streaming to the transmission paths list, and If the data is audio—add audio streaming to the transmission paths list. Note that all three paths may be present.
   c. Determine if the specific data to be sent is available on the in-band or out-of band carousel. If yes—add those paths to the transmission paths list. Note that data that is available on the carousel is usually data that was put there during the network or service configuration process, and not dynamic data generated for specific operations.
   d. Determine available o.o.b. data bandwidth.
2. Discard transmission paths that are not suitable for the type of data/latency constraints
   a. If the Data can not be processed by the set-top box (too large, unsupported type, etc.), discard all paths except for video/audio streaming
   b. Discard paths with latency that is too large for the message/stream. (By way of example, audio/video streaming has latency of at least 0.5 second, while carousels have typical latencies of more then 10 seconds, and up to a few minutes).
3. If list is empty—fail and exit. Otherwise, select optimal transmission path according to a policy. An example set of policy rules may be:
   a. Prefer in-band if available and appropriate
   b. If the data is available on a carousel, prefer using it over transmitting the data via other paths.
   c. Do not use out of band data if available bandwidth is below a predetermined threshold, or a threshold defined in the metadata for the data to be transmitted.
   d. If the carried data contains security sensitive matter—prefer using out-of band data.
4. Process data to suite the selected transmission path: convert format to one that can be handled by the set-top box, MPEG encode video and audio streams, etc.
5. Send/Stream data to the set-top box

Persons skilled in the art will recognize that other sets of rules, or a different data flow may be suitable on different occasions. Each network configuration may require other considerations.

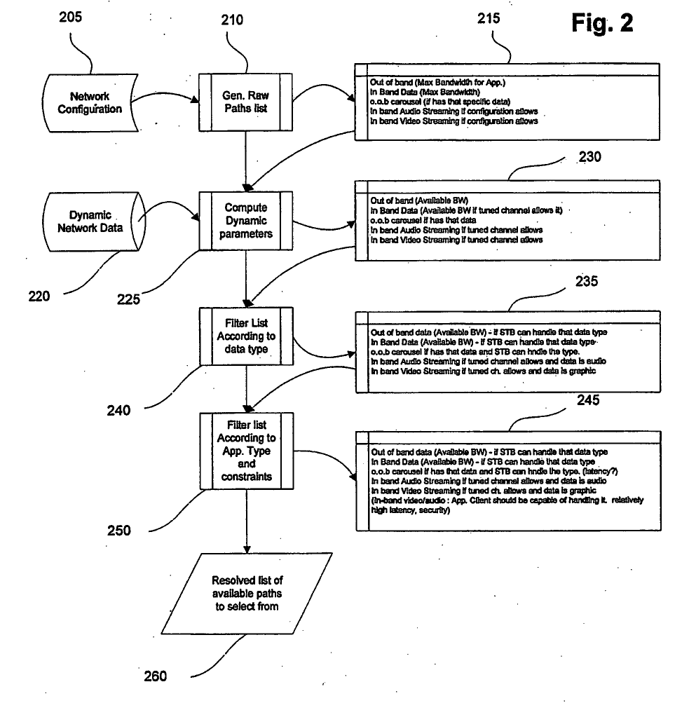

FIG. 2 represents a simplified diagram of the list generation process in the preferred embodiment. A raw path list is generated 210, preferably using network configuration data 205, to generate option list 215. Preferably, dynamic network data 220 is further used in computing the dynamic parameters of the network to derive desirable data paths 230. The data type is then used to select or sort 240 available paths that are optimal to the data type. Finally, the application type hat generated the data to be transmitted, and other constraints, are used 250 to filter the desired paths that make up the list of available paths 260.

FIG. 3 provides an overview of the process beginning in receiving 315 the transmission request as well as the metadata associated therewith (optionally embedded therein). The network configuration 305 and dynamic data 310 are utilised, together with the list of available paths 325 to compile 320 a list of available paths best suited for the metadata, i.e. data such as data type and/or the generating program, required timeliness, and the like.

If the list is empty 35 the process fails 340 and an indication of failure is transmitted to the application, as no suitable path was found. If the list is not empty, and the request included a preferred path 350 and the preferred path is not in the list, 345 the operation again fails 340 (assuming the preferred path is marked as the only suitable path. Naturally, more than one preferred path may be specified. If the preferred path is available, the execution continues to step 365 described below.

If no preferred path was indicated, a set of rules 360 is applied 355 to the list of selected paths to select the most appropriate paths for the data. If the preferred path calls for delivering a stream 365 the stream is generated 370 and the process terminates 385. If the required path is not a stream, it is processed 360 in another way such as a message and delivered 375 prior to completing the process.

Preferably, the sending application is notified of the result of the transmission attempt.

The invention may also be embodied in an apparatus, embodied either in software to be executed on a computer, or by specialized hardware. Naturally a software program that will cause a computer to perform substantially the tasks described above, or a significant portion thereof, also fall within the scope of the invention.

The apparatus comprises a list creator 415, adapted to create a list of available transmission paths from the headend to a specified set-top box, or a group of specified set-top boxes. The list creator in this embodiment is adapted to get information either from a database containing about the capabilities of the specific set-top box, from dynamically querying the set-top, box, from general system capabilities information, or from a combination of those and other sources. For simplicity, the list creator may be considered as having a data retriever module 420 for obtaining the necessary data from various sources like databases 450 and network configuration information 445.

The apparatus also comprises a data route selector 440, to select the best applicable route. The route selector utilizes a policy 460, preferably embedded by a rule base, but which may also be hard coded into the route selector, either by software or hardware. By applying the policy to the combination of available paths list created by the list creator, and the data at hand, the route selector selects the most appropriate path for the data.

Having thus described a presently preferred embodiments of the present invention, it will be understood by those skilled in the art that many changes in construction and circuitry and widely differing embodiments and applications of the invention will suggest themselves without departing from the scope of the present invention as defined in the claims and the description. The disclosures and the description herein are intended to be illustrative and are not in any sense limiting of the invention, defined in scope by the following claims and the previous description and their equivalents.

1. A method for selecting optimized transmission in a television distribution network, the method comprising the steps of:
receiving information relating to data to be transmitted to at least one set-top box, said information comprising metadata related to said data to be transmitted and an identification of said at least one set-top box;
building a list of available transmission paths for the said set-top box;
and selecting an optimal transmission path based on said list and said metadata; and,
transmitting the data to the set-top box using said selected transmission path.

2. The method as claimed in claim 1 wherein said metadata comprises information selected from a list consisting of type of data to be transmitted, type of application that generated the data, type of application to receive the data, latency constraints of the data, or a combination thereof.

3. The method as claimed in claim 1 or 2 wherein said step of building further comprises the step of retrieving information related to said set-top box from a database.

4. The method of claim 3, wherein the retrieved information comprises information on available transmission paths and capabilities of the set-top box.

5. The method as claimed in any preceding claim, further comprising the step of querying said set-top box to obtain data indicative of available transmission paths thereto.

6. The method as claimed in claim 3 or 4, further comprising the step of querying the set-top box to obtain data indicative of available transmission paths thereto.

7. The method as claimed in any preceding claim, further comprising the step of getting information relating to network load and creating said list in accordance with the load information.

8. The method of any of preceding claim, wherein said step of selection is facilitated by a policy.

9. The method according to claim 8, wherein said policy is modifiable.

10. A method according to any preceding claim wherein said step of building further comprises the step of retrieving information relating to load conditions in said distribution system, and wherein said list is constructed in accordance with said load conditions.

11. An apparatus for selecting optimized transmission in a television distribution network having a headend and a plurality of set-top boxes, the apparatus comprises:
a list creator, adapted to create a list of available transmission paths from the headend to a specified set-top box, or a group of specified set-top boxes; and,
a data route selector, adapted to automatically select the best applicable transmission path from said list for transmitting based on a policy applied to the combination of at least a data type to be transmitted and said list.

12. An apparatus as claimed in claim 11 wherein said list creator further comprises an information retriever module adapted for querying a data base for information regarding said set-top box capabilities and transmission paths available thereto

13. an apparatus as claimed in claim 11 or 12 wherein said information retriever module is further adapted to query said set-top box for information on available transmission paths available thereto, or the its capabilities, or a combination thereof.

14. An apparatus as claimed in any of claims 11-13 wherein said list creator further comprises an information retriever module adapted to query said set-top box for information on available transmission paths and capabilities of said set-top box.

15. An apparatus as claimed in any of claims 11-14, wherein said list creator is further adapted for retrieving information relating to network load and creating said list in accordance with the load information.

16. An apparatus as claimed in any of claims 11-15, wherein said list creator is further adapted to retrieve information relating to load conditions of said distribution network, and utilize said information in creating said list
